(19) United States
(12) Patent Application Publication
(10) Pub. No.: US 2023/0281014 A1
(43) Pub. Date: Sep. 7, 2023

(54) PARALLEL PROCESSING OF MULTIPLE LOOPS WITH LOADS AND STORES

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 18/195,407

(22) Filed: May 10, 2023

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/460,909, filed on Apr. 21, 2023.
(60) Provisional application No. 63/447,915, filed on Feb. 24, 2023.
(60) Provisional application No. 63/442,131, filed on Jan. 31, 2023.
(60) Provisional application No. 63/424,960, filed on Nov. 14, 2022.
(60) Provisional application No. 63/424,961, filed on Nov. 14, 2022.
(60) Provisional application No. 63/402,490, filed on Aug. 31, 2022.
(60) Provisional application No. 63/400,087, filed on Aug. 23, 2022.
(60) Provisional application No. 63/393,989, filed on Aug. 1, 2022.
(60) Provisional application No. 63/388,268, filed on Jul. 12, 2022.
(60) Provisional application No. 63/357,030, filed on Jun. 30, 2022.
(60) Provisional application No. 63/340,499, filed on May 11, 2022.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/30

(52) U.S. Cl. CPC G06F 9/30065; G06F 9/30043

(57) ABSTRACT

Techniques for parallel processing of multiple loops with loads and stores are disclosed. A two-dimensional array of compute elements is accessed. Each compute element within the array is known to a compiler and is coupled to its neighboring compute elements within the array. Control for the compute elements is provided on a cycle-by-cycle basis. Control is enabled by a stream of wide control words generated by the compiler. Memory access operations are tagged with precedence information. The tagging is contained in the control words and is implemented for loop operations. The tagging is provided by the compiler at compile time. Control word data is loaded for multiple, independent loops into the compute elements. The multiple, independent loops are executed. Memory is accessed based on the precedence information. The memory access includes loads and/or stores for data relating to the independent loops.

### RELATED APPLICATIONS

This application claims the benefit of U.S. provisional Pat. applications “Parallel Processing Of Multiple Loops With Loads And Stores” Ser. No. 63/340,499, filed May 11, 2022, “Parallel Processing Architecture With Split Control Word Caches” Ser. No. 63/357,030, filed Jun. 30, 2022, “Parallel Processing Architecture With Countdown Tagging” Ser. No. 63/388,268, filed Jul. 12, 2022, “Parallel Processing Architecture With Dual Load Buffers” Ser. No. 63/393,989, filed Aug. 1, 2022, “Parallel Processing Architecture With Bin Packing” Ser. No. 63/400,087, filed Aug. 23, 2022, “Parallel Processing Architecture With Memory Block Transfers” Ser. No. 63/402,490, filed Aug. 31, 2022, “Parallel Processing Using Hazard Detection And Mitigation” Ser. No. 63/424,960, filed Nov. 14, 2022, “Parallel Processing With Switch Block Execution” Ser. No. 63/424,961, filed Nov. 14, 2022, “Parallel Processing With Hazard Detection And Store Probes” Ser. No. 63/442,131, filed Jan. 31, 2023, “Parallel Processing Architecture For Branch Path Suppression” Ser. No. 63/447,915, filed Feb. 24, 2023, and “Parallel Processing Hazard Mitigation Avoidance” Ser. No. 63/460,909, filed Apr. 21, 2023.

This application is also a continuation-in-part of U.S. Pat. application “Highly Parallel Processing Architecture With Compiler” Ser. No. 17/526,003, filed Nov. 15, 2021, which claims the benefit of U.S. provisional Pat. applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. Pat. application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional Pat. applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to parallel processing and more particularly to parallel processing of multiple loops with loads and stores.

### BACKGROUND

The human brain contains billions of interconnected neurons capable of taking in, storing, analyzing, and responding to multiple sources of internal and external stimuli simultaneously. Today’s digital computer systems mimic these functions by using multiple processing units connected to storage systems which receive information from external sources, forward the information to processing systems, and receive the processed information in order to relay it back to the user. Like the human brain, computer systems contain various components which are designed for specific tasks and subtasks. Input and output control, data storage, data processing, and so on are all handled by hardware and software components engineered to perform their specialized tasks as efficiently as possible, within given design parameters and cost thresholds. Operating systems handle routine tasks of controlling communications between hardware components, interfacing with users, managing data flow into and out of processing units, completing basic data storage tasks, and so on. Specialized firmware and software applications handle a wide variety of functions, from data management to 3D visual presentations, from complex mathematical calculations to sound engineering, and many, many others.

All of these applications require data in order to perform their tasks. Dictionaries describe data as factual information, such as measurements or statistics, used as a basis for reference or analysis. Numeric data is perhaps the easiest to understand. Temperature, weight, age, price, velocity, height, depth, and so on can be simply stated as numbers with stated degrees of precision, scales of measurement, and defined meanings. Somewhat less precise are verbal pieces of data, such as hot, cold, tall, short, thin, fat, fast, slow, old, young, and so on. While verbal or written language may be less precise than numeric information, it can also be more flexible, allowing pieces of information to be combined in many various ways that can grow and evolve across time, place, cultures, and people groups. Data elements can be simple or complex, long or short, static or highly changeable. In order to handle such wide arrays of information, storage systems have necessarily become more and more complex, and the amounts of storage being amassed to be summarized or analyzed has grown exponentially. It is estimated that the amount of data held in computer storage systems at the beginning of 2020 was 44 zettabytes. A zettabyte is 10 to the 21^{st} power, which can be written out as a 1 followed by 21 zeros. By 2025, this number will have grown to 175 zettabytes of data, much of it stored and used by multinational corporations and governments.

In general, it is easier to collect and store data than it is to process and present it in meaningful and useful ways. Like young children, data systems and their users sometimes know only what they need to know, and so continue to collect more and more data elements beyond their abilities to process or fully understand them. Nevertheless, the data collected by individual users, companies large and small, governments, and private organizations is highly valued and, in many cases, fiercely protected. As data collection continues, so does the quest to process the data as efficiently and effectively as possible. The rapid processing of large amounts of data is vital to the continued success of every organization that wishes to survive in the modern world.

### SUMMARY

Parallel processing using compute elements is accomplished by parallel processing of multiple loops with loads and stores. A two-dimensional (2D) array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, wherein the tagging is for loop operations, and wherein the tagging is provided by the compiler at compile time. Control word data is loaded for multiple, independent loops into the compute elements. The multiple, independent loops are executed. Memory is accessed based on the precedence information, wherein the memory access includes loads and/or stores for data relating to the independent loops. A control unit is notified by each compute element in the grouping of compute elements, based on each compute element completing loop execution. The notifying indicates loop termination.

A processor-implemented method for parallel processing is disclosed comprising: accessing a two-dimensional (2D) array of compute elements, wherein each compute element within the array of compute elements is known to a compiler and is coupled to its neighboring compute elements within the array of compute elements; providing control for the compute elements on a cycle-by-cycle basis, wherein control is enabled by a stream of wide control words generated by the compiler; tagging memory access operations with precedence information, wherein the tagging is contained in the control words, wherein the tagging is for loop operations, and wherein the tagging is provided by the compiler at compile time; loading control word data for multiple, independent loops into the compute elements; executing the multiple, independent loops; and accessing memory based on the precedence information, wherein the memory access includes loads and/or stores for data relating to the independent loops. In embodiments, a precedence value is determined by logic, based on the precedence information. In embodiments, the precedence information comprises a template value supplied by the compiler, and the template value includes a seed value. In embodiments, the precedence value enables hardware ordering of the loads and stores. Some embodiments comprise establishing a grouping of compute elements within the array of compute elements. And in embodiments, the grouping establishes boundaries for the executing the multiple, independent loops.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for parallel processing of multiple loops with loads and stores.

FIG. 2 is a flow diagram for precedence value handling.

FIG. 3 is a system block diagram for parallel processing of multiple loops.

FIG. 4 illustrates an array of compute elements with contiguous groupings.

FIG. 5 illustrates a system block diagram for a highly parallel architecture with a shallow pipeline.

FIG. 6 illustrates compute element array detail.

FIG. 7 shows loop implementation detail.

FIG. 8 illustrates a system block diagram for compiler interactions.

FIG. 9 is a system diagram for parallel processing of multiple loops with loads and stores.

### DETAILED DESCRIPTION

Techniques for parallel processing of multiple loops with loads and stores are disclosed. Substantial efficiency and throughput improvements to task processing are accomplished with two-dimensional (2D) arrays of elements. The 2D arrays of elements can be configured and used for the processing of the tasks and subtasks. The 2D arrays include compute elements, multiplier elements, registers, caches, queues, register files, buffers, controllers, decompressors, arithmetic logic units (ALUs), storage elements, and other components. Communication elements enable communication among the various elements. These arrays of elements are configured and operated by providing control to the array of elements on a cycle-by-cycle basis. The control of the 2D array is enabled by a stream of wide control words. The control words can include wide, variable length, microcode control words generated by the compiler. The control words can comprise compute element operations. The control words can be variable length, as described by the architecture, or they can be fixed length. However, a fixed length control word can be compressed, which can result in variable lengths for operational usage to save space. The control can include precedence information. The precedence information can be used by hardware to derive a precedence value, where the precedence information comprises a template value supplied by the compiler. The template value can include a seed value. The precedence value enables hardware ordering of the load and store operations performed by multiple, independent loops. The ordering of loads and stores can be used to identify load hazards and store hazards. The hazards can be avoided by delaying promoting data to a store buffer.

In a processing architecture such as an architecture based on configurable compute elements as described herein, the loading and storing of data can cause execution of a process, task, subtask, and the like to stall operations in the array. The stalling can cause execution of a single compute element to halt or suspend, which requires the entire array to stall because the hardware must be kept in synchronization with compiler expectations on an architectural cycle basis, described later. The halting or suspending can continue while needed data is stored or fetched or completes operation. The compute element array as a whole stalls if external memory cannot supply data in time, or if a new control word cannot be fetched and/or decompressed in time, for example. In addition, a multicycle, nondeterministic duration operation, such as a divide operation, in a multicycle element (MEM) may take longer than scheduled, in which case the compute element array would have to stall while waiting for the MEM operation to complete (when that result is to be taken into the array as an operand). Noted throughout, control for the array of compute elements is provided on a cycle-by-cycle basis. The control that is provided to the array of compute elements is enabled by a stream of wide control words generated by a compiler. The control words can be of variable length. The compiler can further provide precedence information that can be used by the memory system supporting the array of compute elements to order load operations and store operations. The ordering based on the precedence information can include hints, such as a numerical sequence, that enable the memory system to perform loads and stores while maintaining data integrity. The ordering can be based on identifying load hazards and store hazards, generally known as memory hazards, where a hazard can include storing data over valid data, reading invalid data, and so on. The hazards can include write-after-read, read-after-write, write-after-write, and similar conflicts. The hazards can be avoided based on a comparative precedence value. The hazards can be avoided by holding the loads and stores in an access buffer “in front” of memory (between data caches and a crossbar switch, described subsequently), and load and/or store delays are managed in terms of when the loads and stores are allowed to proceed to and/or from memory (in some cases, store data can be immediately returned as load data, such as for store-to-load forwarding). A key function of the crossbar is to spatially localize accesses that may conflict so that the reordering can occur. The compute elements within the 2D array of compute elements can be configured to perform parallel processing of multiple, independent loops. Each loop can include a set of compute element operations, and the set of compute element operations can be executed a number of times (i.e., iterations). Groupings of compute elements can be established within the array of compute elements, and the multiple, independent loops can be assigned to the established groupings.

The specific set of compute element operations that comprises an independent loop can be loaded into one or more of caches, storage elements, registers, etc., including an additional small memory in a compute element called a bunch buffer, where a bunch is that group of bits in a control word that controls a single compute element. Essentially, each bunch buffer will contain the bits (i.e., a “bunch”) that would otherwise be driven into the array to control a given compute element. In addition, a compute element may include its own small “program counter” to index into the bunch buffer, and may also have the ability to take a “micro-branch” within that compute element. For physically close clusters of compute elements to cooperate on a loop, the “micro-branch” decisions can be broadcast to all cooperating members of that cluster. The bunch buffer can comprise a one read port and write port (1R1W) register. Alternatively, the registers can be based on a memory element with two read ports and one write port (2R1W). The 2R1W memory element enables two read operations and one write operation to occur substantially simultaneously. An associative memory can be included in each compute element of the topological set of compute elements. The associative memory can be based on a 2R1W register, where the 2R1W register can be distributed throughout the array. The specific sets of operations associated with multiple, independent loops can be written to an associative memory associated with each compute element within the 2D array of compute elements. The specific sets of operations can configure the compute elements, enable the compute elements to execute operations within the array, and so on. The compute element groupings can include a topological set of compute elements from the 2D array of compute elements. The topological set of compute elements can be configured by control words provided by the compiler. The configuring the compute elements can include placement and routing information for the compute elements and other elements within the 2D array of compute elements. The specific set of compute element operations associated with the multiple, independent loops can include a number of operations that can accomplish some or all of the operations associated with a task, a subtask, and so on. By providing a sufficient number of operations, autonomous operation of the compute element can be accomplished. The autonomous operation of the compute element can be based on operational looping, where the operational looping is enabled without additional control word template loading. The looping can be enabled based on ordering load operations and store operations such that memory access hazards are avoided. Recall that latency associated with access by a compute element to storage, that is, memory external to a compute element or to the array of compute elements, can be significant and can cause the compute element array to stall. By performing operations within a compute element grouping, latency can be eliminated, thus expediting the execution of operations.

Tasks and subtasks that are executed by the compute elements within the array of compute elements can be associated with a wide range of applications. The applications can be based on data manipulation, such as image or audio processing applications, facial recognition, voice recognition, AI applications, business applications, data processing and analysis, and so on. The tasks that are executed can perform a variety of operations including arithmetic operations, shift or rotate operations, logical operations including Boolean operations, vector or matrix operations, tensor operations, and the like. The subtasks can be executed based on precedence, priority, coding order, amount of parallelization, data flow, data availability, compute element availability, communication channel availability, and so on.

The data manipulations are performed on a two-dimensional (2D) array of compute elements (CEs). The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage, which can include local memory elements, register files, cache storage, associative memories, etc. The cache, which can include a hierarchical cache such as an “L1”, “L2”, and “L3” cache, can be used for storing data such as intermediate results, compressed control words, coalesced control words, decompressed control words, relevant portions of a control word, and the like. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional array of compute elements.

The tasks, subtasks, etc., that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), a constraint-based and satisfiability-based compiler, and so on. Control is provided to the hardware in the form of control words, where one or more control words are generated by the compiler. The control words are provided to the array on a cycle-by-cycle basis. The control words can include wide microcode control words. The length of a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. Noting that the compiled microcode control words that are generated by the compiler are based on bits, the control words can be compressed by selecting bits from the control words. The control of the compute elements can be accomplished by a control unit.

Parallel processing includes parallel processing of multiple loops with loads and stores. The parallel processing can include data manipulation by multiple independent loops. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA), and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Control for the compute elements is provided on a cycle-by-cycle basis. Control is enabled by a stream of wide control words generated by the compiler. The cycle can include a clock cycle, a data cycle, a processing cycle, a physical cycle, an architectural cycle, etc. The control word lengths can vary based on the type of control, compression, simplification such as identifying that a compute element is unneeded, etc. The control words, which can include compressed control words, can be decoded and provided to a control unit which controls the array of compute elements. The control word can be decompressed to a level of fine control granularity, where each compute element (whether an integer compute element, floating point compute element, address generation compute element, write buffer element, read buffer element, etc.), is individually and uniquely controlled. A compressed control word can be decompressed to allow control on a per element basis. The decoding can be dependent on whether a given compute element is needed for processing a task or subtask; whether the compute element has a specific control word associated with it or the compute element receives a repeated control word (e.g., a control word used for two or more compute elements), and the like.

Memory access operations are tagged with precedence information. The precedence information can be supplied by the compiler and can include a template value. The template value can include an absolute value, a relative value, a value that can be used as a pointer, and so on. The template value can include a seed value. The precedence value, which can be determined by the hardware, can enable hardware ordering of load operations and store operations to maintain in-order semantic correctness. The ordering enables the loading and the storing to be accomplished while avoiding memory access hazards. The tagging can be contained in the control words. The tagging can include fixed or variable bit widths. The tagging can be used for loop operations such as multiple independent loops. The multiple, independent loops can be used to perform parallel processing operations. The tagging is provided by the compiler at compile time. Control word data for multiple, independent loops is loaded into the compute elements. The compute elements can include compute elements within established groupings of compute elements. The groupings can establish boundaries for executing the multiple, independent loops. The multiple, independent loops are executed. Execution of the loops can include repeating executing loop operations. Memory is accessed based on the precedence information, wherein the memory access includes loads and/or stores for data relating to the independent loops. The memory loads and stores are ordered such that memory access hazards are avoided.

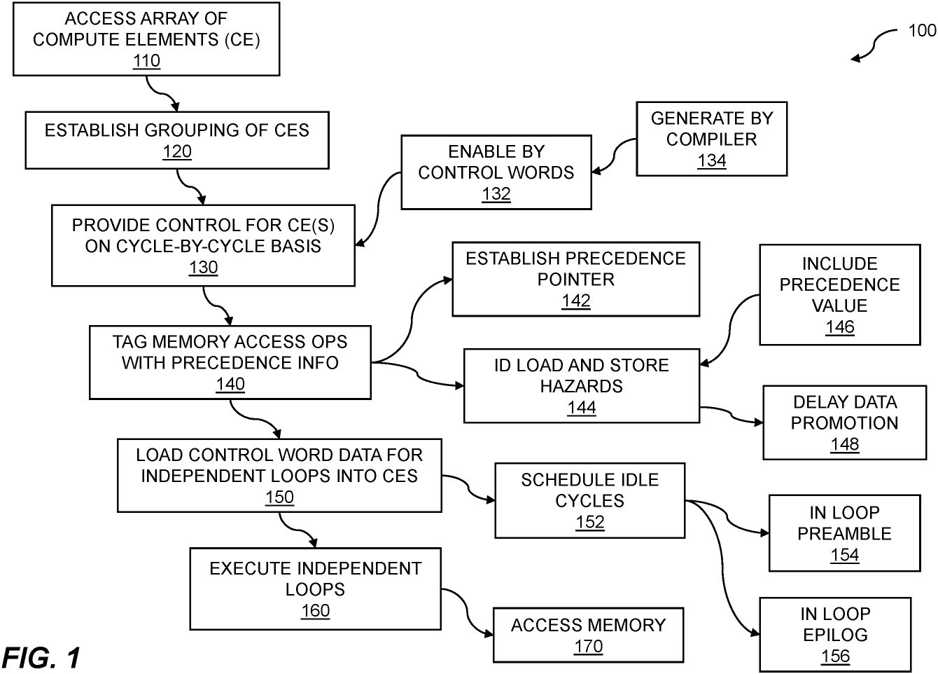

FIG. 1 is a flow diagram for parallel processing of multiple loops with loads and stores. Groupings of compute elements (CEs), such as CEs assembled within a 2D array of CEs, can be configured to execute a variety of operations associated with data processing. The operations can be based on tasks and on subtasks, where the subtasks are associated with the tasks. The tasks and subtasks that can be associated with multiple, independent loops include load operations and store operations. The 2D array can further interface with other elements such as controllers, storage elements, ALUs, memory management units (MMUs), graphics processing units (GPUs), multiplier elements, and so on. The loop operations can accomplish a variety of processing objectives such as application processing, data manipulation, data analysis, and so on. The operations can manipulate a variety of data types including integer, real, and character data types; vectors and matrices; tensors; etc. In embodiments, the compute element operations can include arithmetic logic unit (ALU) operations. Each compute element within the array of compute elements is known to a compiler and is coupled to its neighboring compute elements within the array of compute elements. Control for the compute elements is provided on a cycle-by-cycle basis. The control is enabled by a stream of wide control words generated by the compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence data provision and compute element results. The control enables execution of a compiled program on the array of compute elements.

The flow 100 includes accessing a two-dimensional (2D) array 110 of compute elements, wherein each compute element within the array of compute elements is known to a compiler and is coupled to its neighboring compute elements within the array of compute elements. The compute elements within the 2D array can be based on a variety of types of computers, processors, and so on. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by a control word (discussed below) to implement one or more of a systolic, a vector, a cyclic, a spatial, a streaming, or a Very Long Instruction Word (VLIW) topology.

The compute elements can further include a topology suited to machine learning computation. The compute elements can be coupled to other elements within the array of CEs. In embodiments, the coupling of the compute elements can enable one or more topologies. The other elements to which the CEs can be coupled can include storage elements such as one or more levels of cache storage; multiplier units; address generator units for generating load (LD) and store (ST) addresses; queues; and so on. The compiler to which each compute element is known can include a C, C++, or Python compiler. The compiler to which each compute element is known can include a hardware description language (HDL) compiler, a compiler written especially for the array of compute elements, etc. The coupling of each CE to its neighboring CEs enables sharing of elements such as cache elements, multiplier elements, ALU elements, or control elements; communication between or among neighboring CEs; and the like.

The flow 100 further includes establishing a grouping 120 of compute elements within the array of compute elements. A grouping can include two or more compute elements within the array. The groupings can include various configurations. In a usage example, the groupings can be represented by a matrix notation such as a 1 × 4 matrix, a 2 × 2 matrix, and so on. The compute elements within a grouping can include adjacent compute elements. The adjacent compute elements can be in direct communication with one another, and can share storage elements, controllers, arithmetic logic units (ALU), multipliers, etc. In embodiments, the grouping can establish boundaries for the executing the multiple, independent loops. The independent loops can perform one or more compute element operations one or more times (i.e., iterations). The grouping can support locality of data. That is, data that can be accessed by compute elements with the grouping can share storage components. The sharing storage components, such as local memory, reduces memory access times for loading and storing. The grouping can be based on the coupling of compute elements within the 2D array of compute elements to their nearest neighbors. In embodiments, a coupling of the at least one grouping of compute elements can be performed dynamically at run time. Some embodiments comprise notifying a control unit by each compute element, in the at least one grouping of compute elements, based on each compute element completing loop execution. In embodiments, the notifying indicates loop termination. Some embodiments comprise idling each compute element in the grouping of compute elements upon loop termination.

The flow 100 includes providing control for the compute elements on a cycle-by-cycle basis 130. The control for the array can include configuration of elements such as compute elements within the array; loading and storing data; routing data to, from, and among compute elements; and so on. In the flow 100, the control is enabled 132 by a stream of wide control words. The control words can configure the compute elements and other elements within the array; enable or disable individual compute elements, rows and/or columns of compute elements; load and store data; route data to, from, and among compute elements; and so on. The one or more control words are generated 134 by the compiler. The compiler which generates the control words can include a general-purpose compiler such as a C, C++, or Python compiler; a hardware description language compiler such as a VHDL or Verilog compiler; a compiler written for the array of compute elements; and the like. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data, nor is a control word required by it. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The control words that are generated by the compiler can include a conditionality. In embodiments, the control includes a branch. Code, which can include code associated with an application such as image processing, audio processing, and so on, can include conditions which can cause execution of a sequence of code to transfer to a different sequence of code. The conditionality can be based on evaluating an expression such as a Boolean or arithmetic expression. In embodiments, the conditionality can determine code jumps. The code jumps can include conditional jumps as just described, or unconditional jumps such as a jump to a halt, exit, or terminate operation. The conditionality can be determined within the array of elements. In embodiments, the conditionality can be established by a control unit. In order to establish conditionality by the control unit, the control unit can operate on a control word provided to the control unit. In embodiments, the control unit can operate on decompressed control words. The control words can be decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple programming loop instances circulating within the array of compute elements. The multiple programming loop instances can include multiple instances of the same programming loop, multiple programming loops, etc.

The flow 100 includes tagging memory access operations 140 with precedence information. The precedence information can be used to indicate a precedence or priority of data operations such as load operations and store operations. The precedence information can be used to define or identify data dependencies. The tagging is contained in the control words, wherein the tagging is implemented for loop operations, and wherein the tagging is provided by the compiler at compile time. The precedence information can be particularly relevant to parallel processing of multiple, independent loops of operations. The loops of operations can be performed, “looped”, or iterated a number of times. The precedence information can include a value, a relative value, an offset, etc. In embodiments, a precedence value can be determined by the hardware, based on the precedence information. The deriving a precedence value can be accomplished by one or more compute elements within the 2D array. In embodiments, the precedence information can include a template value supplied by the compiler. The template value can include a value, a relative value, an offset, etc. In other embodiments, the template value includes a seed value. The seed value can be used to initiate a derivation of a precedence value. In embodiments, the precedence value can enable hardware ordering of the loads and stores. The hardware ordering of loads and stores can prevent memory access hazards.

The flow 100 further includes establishing a precedence pointer 142 for the grouping. When compute elements are operating using their bunch buffers, a control unit for the architecture may or may not be operating, or it may be operating in a more limited form in that it is only supplying precedence or other data that cannot be sourced by the compute element executing a loop. Memory hazard detection and resolution, though, occur in the access buffers on the far side of the crossbar where the same addresses are physically localized by the crossbar. The precedence pointer can be used to track one or more memory access operations. In embodiments, the precedence pointer can indicate actual hardware progress of the loads and stores. The tracking of actual hardware progress can include tracking of load and store operations for each iteration of an independent loop. The flow 100 further includes identifying load hazards and store hazards 144. A load hazard can include loading invalid data, a store hazard can include overwriting valid data, and so on. The identifying load hazards and store hazards can be accomplished by comparing load and store addresses to contents of an access buffer. The access buffer can include data loaded for storage such as memory, data to be stored back to memory, and so on. The comparing load and store addresses to the contents of the access buffer can be used to determine whether needed data is available for loading, valid data is ready for storage in memory, etc. The flow 100 comprises including the precedence value 146 in the comparison. In a usage example, two store operations can access the same address in memory. The choice of which store operation precedes the other can be determined based on the precedence value. The flow 100 further includes delaying the promoting of data 148 to a data cache access buffer. The access buffer can delay, or hold, store data for the cache and/or load data from the cache until all hazards are resolved by memory system logic, based on the precedence information. In embodiments, the delaying can avoid hazards. In a usage example, a hazard can be avoided by delaying a store operation that would overwrite data that has yet to loaded by an operation that processes the data. The delaying can further prevent storing data out of order. In embodiments, the avoiding hazards can be based on a comparative precedence value. The comparative precedence value can determine an order for store operations based on the precedence of store operations being higher, lower, or the same precedence. In embodiments the hazards can include write-after-read, read-after-write, and write-after-write conflicts, etc. A store operation can be cleared from the access buffer. In embodiments, a store operation can be cleared from an access buffer when the precedence pointer is greater than the precedence value of the store operation, and all load operations with lower precedence values have completed.

The flow 100 includes loading control word data 150 for multiple, independent loops into the compute elements. Each independent loop can include one or more operations within a set of operations. The control word data can be provided as a stream of wide control words generated by the compiler. Each set of operations in an independent loop can be repeated, “looped”, or iterated a number of times. The control word data associated with the independent loops can include different numbers of operations for each loop. The control words can include one or more operations that can accomplish data processing. The data can include integer, real (e.g., floating point), or character data; vector, matrix, or array data; tensor data; etc. The data can be associated with a type of processing application such as image data for image processing, audio data for audio processing, etc. The loading control word data can be accomplished by loading control word data from a register file, from a cache, from storage internal to the array, from external storage coupled to the array, and so on. The data can include data generated by an independent loop, by sides of a branch, where the branch path can be executed in the array.

The multiple, independent loops can include code for a preamble, a loop, and an epilog. The code preamble can be used to configure compute elements within groupings of compute elements, to reserve storage, to access data or preload data, and so on. The loop can include one or more operations that can be executed once or can be repeated for a number of iterations. The epilog can store data, can free compute element resources, and the like. The prolog, the code, and the epilog of one independent loop can include a number of operations that is different from the number of operations associated with the prolog, the code, and the epilog associated with a second independent loop. The flow 100 further includes scheduling 152 idle cycles. An idle cycle can include one or more “no operation” (NOP) command words or similar command words. The idle cycles can accomplish synchronization, retiming, etc. The flow 100 includes scheduling idle cycles, by the compiler, in the independent loop preamble 154. The scheduled idle cycles can include zero or more idle cycles. In embodiments, the preamble idle cycles can enable each compute element in the grouping of compute elements to complete preamble code before starting loop execution. Synchronization or retiming can also be associated with the loop epilog. The flow 100 further includes scheduling 156 idle cycles, by the compiler, in the independent loop epilog. As with the preamble, the epilogs of different loops can include different numbers of operations. The idle cycles can be used to synchronize, retime, or otherwise equalize operations associated with the loop epilogs. In embodiments, the epilog idle cycles can enable each compute element in the grouping of compute elements to complete epilog code before exiting operation loop execution.

The flow 100 includes executing 160 the multiple, independent loops. Each loop associated with the multiple, independent loops includes one or more operations. The operations can include arithmetic operations, logical operations, matrix operations, tensor operations, and so on. The operations that are executed are contained in the control words. Discussed above, the control words can include a stream of wide control words generated by the compiler. The control words can be used to control the array of compute elements on a cycle-by-cycle basis. A cycle can include a local clock cycle, a self-timed cycle, a system cycle, and the like. In embodiments, the executing occurs on an architectural cycle basis. An architectural cycle can include a read-modify-write cycle. In embodiments, the architectural cycle basis reflects non-wall clock, compiler time. The execution can include distributed execution of operations. In embodiments, the distributed execution of operations can occur in two or more compute elements within the array of compute elements, within a grouping of compute elements, and so on. The compute elements can include independent compute elements, clustered compute elements, etc. Execution of specific compute element operations can enable parallel operation processing. The parallel operation processing can include processing nodes of a graph that are independent of each other, processing independent tasks and subtasks, etc. The operations can include arithmetic, logic, array, matrix, tensor, and other operations. A given compute element can be enabled for operation execution, idled for a number of cycles when the compute element is not needed, etc. The operations that are executed can be repeated. An operation can be based on a plurality of control words.

The operation that is being executed can include data dependent operations. In embodiments, the plurality of control words includes two or more data dependent branch operations. The branch operation can include two or more branches, where a branch is selected based on an operation such as an arithmetic or logical operation. In a usage example, a branch operation can determine the outcome of an expression such as A > B. If A is greater than B, then one branch can be taken. If A is less than or equal to B, then another branch can be taken. In order to expedite execution of a branch operation, sides of the branch can be precomputed prior to datum A and datum B being available. When the data is available, the expression can be computed, and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the generating, the customizing, and the executing can enable background memory access. The background memory access can enable a control element to access memory independently of other compute elements, a controller, etc. In embodiments, the background memory access can reduce load latency. Load latency is reduced since a compute element can access memory before the compute element exhausts the data that the compute element is processing.

The flow 100 includes accessing memory 170 based on the precedence information, wherein the memory access includes loads and/or stores for data relating to the independent loops. The memory is accessed by the loops while the loops are executing operations. Recall that operations within the 2D array of compute elements can operate substantially autonomously, without having to send and receive control and status signals to a control unit located outside the 2D array. Therefore, the loops can communicate loop operation status to a local control element. Loop operation status can include initialized, loading, executing, idling, stalled, done, and so on. Loop termination can occur when each operation within a loop has been executed for a number of iterations. An iteration count can include one or more iterations.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

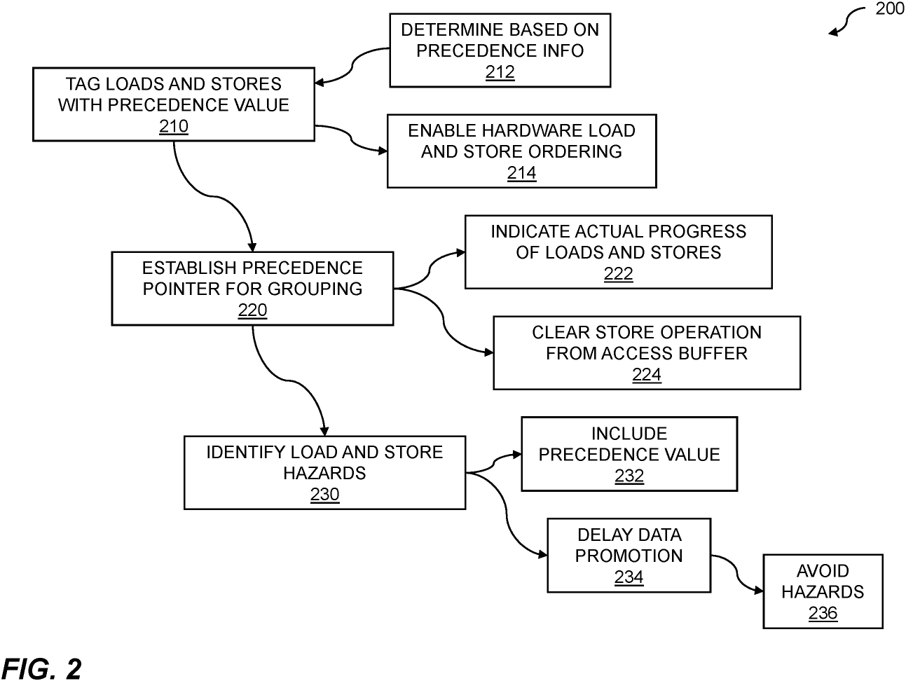

FIG. 2 is a flow diagram for precedence value handling. Precedence values can be based on precedence information that can be provided by a compiler. The precedence information can be used by hardware to derive a precedence value, where the precedence value can be used to order memory access operations such as load operations and store operations. The ordering of the load and store operations can prevent memory access hazards. The precedence values enable parallel processing of multiple, independent loops with loads and stores. Parallel processing is accomplished by executing sets of compute element operations, for a number of iterations, on groupings of compute elements established within a 2D array of compute elements. The sets of compute element operations can be associated with multiple, independent loops that include load operations and store operations. Collections, clusters, or groupings of compute elements (CEs), such as CEs assembled within a 2D array of CEs, can be configured to execute a variety of operations associated with programs, codes, apps, loops, and so on. The operations can be based on tasks, and on subtasks that are associated with the tasks. The 2D array can further interface with other elements such as controllers, storage elements, ALUs, MMUs, GPUs, multiplier elements, convolvers, and the like. The operations can accomplish a variety of processing objectives such as application processing, data manipulation, design and simulation, and so on. The operations can perform manipulations of a variety of data types including integer, real, floating point, and character data types; vectors and matrices; tensors; etc. A two-dimensional (2D) array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, wherein the tagging is implemented for loop operations, and wherein the tagging is provided by the compiler at compile time. Control word data for multiple, independent loops is loaded into the compute elements. The multiple, independent loops are executed. Memory is accessed based on the precedence information, wherein the memory access includes loads and/or stores for data relating to the independent loops.

Operations associated with the multiple, independent loops can be stored in one or more associative memories. An associative memory can be included with each compute element. By using the control words provided on a cycle-by-cycle basis, a controller configures array elements such as compute elements, and enables execution of a compiled program on the array. The compute elements can access registers, scratchpads, caches, and so on that contain control words, data, etc. The compute elements can further be designated in a topological set of compute elements (CEs). The topological set of CEs can implement one or more topologies, where a topology can be mapped by the compiler. The topology mapped by the compiler can include a graph such as a directed graph (DG) or directed acyclic graph (DAG), a Petri Net (PN), etc. In embodiments, the compiler maps machine learning functionality to the array of compute elements. The machine learning can be based on supervised, unsupervised, and semi-supervised learning; deep learning (DL); and the like. In embodiments, the machine learning functionality can include a neural network implementation. The compute elements can be coupled to other elements within the array of CEs. In embodiments, the coupling of the compute elements can enable one or more topologies. The other elements to which the CEs can be coupled can include storage elements such as one or more levels of cache storage, multiplier units, address generator units for generating load (LD) and store (ST) addresses, queues, and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multiplier elements, ALU elements, or control elements; communication between or among neighboring CEs; and the like.

The flow 200 includes tagging memory access operations 210 with precedence information. Discussed previously, precedence information can be associated with memory access operations such as load and store operations. The tagging can be contained in the control words, wherein the tagging is for loop operations, and wherein the tagging is provided by the compiler at compile time. The precedence information can be used to indicate dependencies between load and store operations. The precedence information can be processed by hardware such as compute elements, controllers, and so on. In the flow 200, a precedence value can be determined 212 by the hardware, based on the precedence information. The precedence value can indicate a precedence, a relative precedence, and the like. The hardware can include logic within the array of compute elements, logic coupled to the array of compute elements, logic present in or near a crossbar switch coupled to the array of compute elements, and so on. In embodiments, the template value can include a seed value. In the flow 200, the precedence value can enable hardware ordering 214 of the loads and stores. The precedence value can include a specific value, a relative value, a rank, a priority, and the like. In a usage example, a second loop can process data generated by a first loop as the data is generated by the first loop. In order for the second loop to process valid data, the second loop delays the loading of data until the first loop has generated and stored the data. Otherwise, a load hazard condition can exist where the second loop could load invalid data.

The flow 200 further includes establishing a precedence pointer 220 for a grouping. The grouping can include a grouping of compute elements established within the 2D array of compute elements. The grouping can include two or more compute elements. The grouping can include other elements within the 2D array such as multiplier elements, arithmetic logic unit (ALU) elements, and the like. In the flow 200, the precedence pointer can indicate actual hardware progress 222 of the loads and stores. Recall that the multiple, independent loops can include a set of operations to be executed on a grouping of compute elements, and that the set of operations can be repeated (“looped”) for a number of iterations. Since the compute elements can operate substantially independently of a processor located remotely from the 2D array of compute elements, the progress by the hardware to perform loads and stores can be tracked or indicated by the precedence pointer. In the flow 200, a store operation is cleared from an access buffer 224 when the precedence pointer is greater than the precedence value of the store operation and all load operations with lower precedence values have completed. By using this technique, data waiting to be loaded by a loop will not be overwritten with new data, thereby preventing a hazard condition.

The flow 200 further includes identifying load hazards and store hazards 230. A load hazard can include an attempt to read or load data that is invalid or not yet available for loading. A store hazard can include an attempt to store data over existing data which has not yet been loaded. The load and store hazards, if executed, can cause severe processing errors. The hazards can cause processing errors because invalid data can be loaded and processed instead of the correct or valid data. The processing errors can also be caused by overwriting data that has not yet been loaded for processing elsewhere. The load and store hazards can be identified prior to executing an operation that would cause a hazard. This can be accomplished by comparing load and store addresses to contents of an access buffer. The flow 200 further comprises including the precedence value 232 in the comparison. Recall that the precedence value can be determined by the hardware, based on the precedence information. The precedence information can include a template value, where the template value can include a seed value. The flow 200 further includes delaying the promoting of data 234 to the store buffer. The store buffer can be used to hold data prior to storing data based on a memory access technique. In the flow 200, by delaying promoting the data to store buffer, the storing of the data can be delayed thereby avoiding a hazard 236 resulting from overwriting data prior to the data being loaded by a loop that requires the data. In embodiments, the avoiding hazards can be based on a comparative precedence value. The comparison of precedence values can identify precedence values with higher values, lower values, equal values, etc. In embodiments, a store operation is cleared from an access buffer when the precedence pointer is greater than the precedence value of the store operation and all load operations with lower precedence values have completed.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

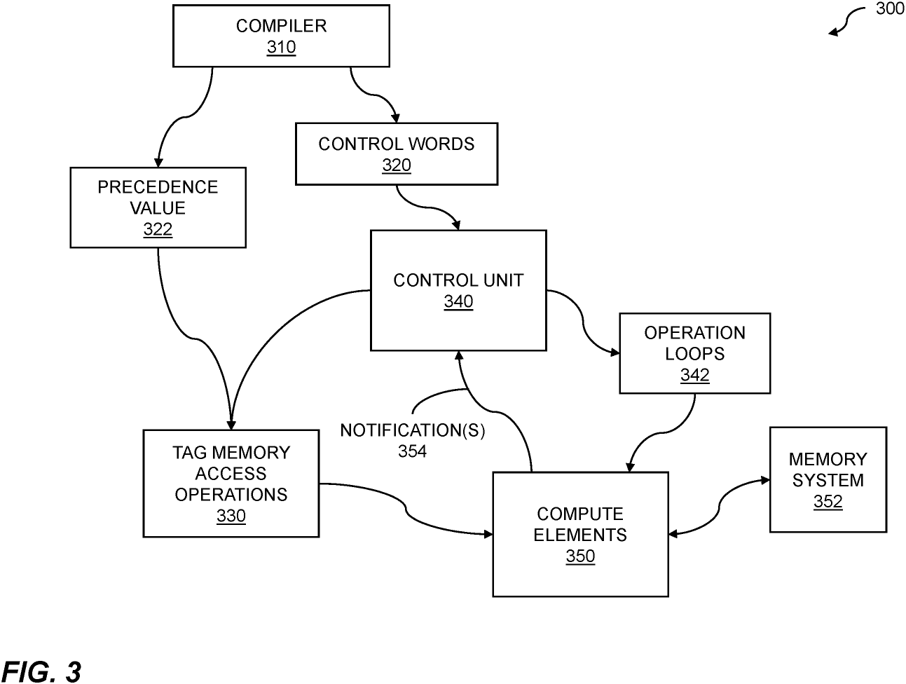

FIG. 3 is a system block diagram for parallel processing of multiple loops. The multiple loops can include independent loops, where the independent loops can be processed in parallel. An iteration number or iteration count can be associated with a loop, where the iteration count can be used to indicate a number of times execution of the loop can be repeated. The parallel processing of the multiple loops can be accomplished using compute elements within a 2D array of compute elements. The compute elements can perform a variety of operations such as arithmetic, logical, matrix, and tensor operations. The array of compute elements can be configured to perform higher level processing operations such as video processing and audio processing operations. The array can be further configured for machine learning functionality, where the machine learning functionality can include a neural network implementation. The parallel processing of multiple loops includes parallel processing of multiple loops with loads and stores. A two-dimensional (2D) array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, wherein the tagging is for loop operations, and wherein the tagging is provided by the compiler at compile time. Control word data is loaded for multiple, independent loops into the compute elements. The multiple, independent loops are executed. Memory is accessed based on the precedence information, wherein the memory access includes loads and/or stores for data relating to the independent loops.

The system block diagram 300 can include a compiler 310. The compiler can include a general-purpose or high-level compiler, a specialized compiler, etc. A high-level compiler can include a C, C++, Python, or similar compiler. A special-purpose compiler can include a hardware description language compiler such as a VHDL™ or Verilog™ compiler. The compiler can include a compiler for a representation such as a portable, language-independent, intermediate representation such as low-level virtual machine (LLVM) intermediate representation (IR). In the system block diagram 300, the compiler can generate a set of control words 320, where the control words can represent a circuit topology. A circuit topology can include a systolic, a vector, a cyclic, a streaming, or a Very Long Instruction Word (VLIW) topology, a neural network topology, etc. The compiler can generate a set of control words that enable parallel processing of multiple loops with load and store operations. The compiler can be used to compile tasks, subtasks, and so on. The tasks and subtasks can be based on a processing application. The compiler can generate directions for handling compute element results. The compute element results can include results derived from arithmetic, vector, array, and matrix operations; Boolean operations; and so on. The block diagram 300 can include a precedence value 322. In embodiments, a precedence value can be determined by the hardware, based on precedence information. The precedence information can be used to determine a precedence for one or more load and store operations, where the load and store operations can be associated with multiple, independent loops. In embodiments, the precedence value enables hardware ordering of the loads and stores. The ordering of loads and stores can be used to prevent storage access hazards. In embodiments, the precedence information comprises a template value supplied by the compiler. The template value can include a single value, an offset value, a relative value, and so on. In embodiments, the template value can include a seed value.

The system 300 can tag memory access operations 330. The memory access operations, which can include load and store operations, can be tagged with precedence information. Discussed above and throughout, the precedence information enables the load and store operations while avoiding load and store hazards. In embodiments, the tagging can be contained in the control words. The tagging can be for loop operations, and the tagging can be provided by the compiler at compile time. The tagging can enable autonomous operations of one or more compute elements within the 2D array of compute elements. Embodiments can include identifying load hazards and store hazards by comparing load and store addresses to contents of an access buffer. Hazards can occur when valid data is not available at a time of a load, a store operation corrupts valid data, and so on. Embodiments can comprise including the precedence value in the comparison. Various techniques can be used to avoid load hazards and store hazards. Embodiments can include delaying the promoting of data to the store buffer. The delaying data promotion can prevent overwriting data, loading invalid data, etc. In embodiments, the delaying avoids hazards. The avoiding hazards can be based on precedence values for load operations and store operations. In embodiments, the avoiding hazards is based on a comparative precedence value. The memory access operations hazards can include a variety of access hazards. In embodiments the hazards can include write-after-read, read-after-write, and write-after-write conflicts.

The system block diagram 300 can include a control unit 340. The control unit can configure one or more compute elements within the 2D array of compute elements; can idle individual compute elements, rows, or columns of compute elements; and so on. The control unit can configure groupings of compute elements. Embodiments can include establishing a grouping of compute elements within the array of compute elements. The grouping can execute control words associated with an independent loop. In the system block diagram 300, the control unit can load control word data for multiple, independent operation loops 342 into compute elements with the 2D array of compute elements (discussed below). Multiple groupings can be configured to enable execution of multiple, independent loops. In embodiments, the grouping can include boundaries for the executing the multiple, independent loops. The boundaries can enable data locality, independent execution of a loop, etc. A pointer can be associated with a grouping. Embodiments can include establishing a precedence pointer for the grouping. The pointer can be used to indicate memory access progress. In embodiments the precedence pointer can indicate actual hardware progress of the loads and stores.

The system block diagram 300 can include compute elements 350. The compute elements can include compute elements with a 2D array of compute elements. The compute within the 2D array of compute elements can include heterogeneous processors, homogeneous processors, processor cores within an integrated circuit or chip, and so on. The compute elements can be coupled to local storage, which can include local memory elements, register files, cache storage, associative memories, etc. The compute elements can be further coupled to control elements such as control unit 340, multiplier elements, arithmetic logic unit (ALU) elements, etc. The contiguous groupings of compute elements can include two or more compute elements, where the contiguous groupings can be configured in a horizontal or vertical orientation; a rectangular, square, or “straight line” orientation; etc.

The operation loops can be loaded into the compute element groupings by the control unit. One or more memory systems such as memory system 352 can be associated with the compute elements. The memory system can include local storage, cache memory, and so on. The cache can be accessed by one or more compute elements. The cache, if present, can include a dual read, single write (2R1W) cache. That is, the 2R1W cache can enable two read operations and one write operation contemporaneously without the read and write operations interfering with one another. The control unit can initiate execution by the compute elements of the multiple, independent loops. The execution of the loops can include executing a number of operations for a number of iterations. Embodiments can include notifying 354 a control unit by each compute element in the grouping of compute elements, based on each compute element completing loop execution. The notification can include a signal, a flag, a semaphore, a message, an indication, and so on. The control unit can monitor for the completion of each loop among the multiple, independent loops. In embodiments, the notifying can indicate loop termination. Each loop can notify the control unit of termination. Receipt of notifications can indicate that the multiple, independent loops have executed their control words for a number of iterations.

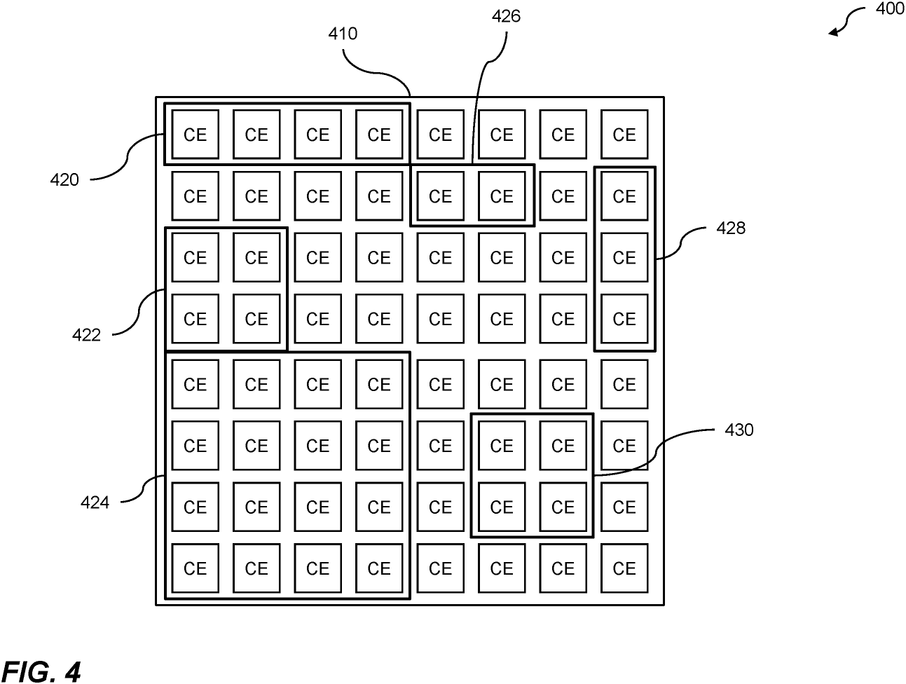

FIG. 4 illustrates an array of compute elements with contiguous groupings. Parallel processing techniques can be applied to execution of multiple, independent loops that comprise load operation and store operations. In order for the execution of the multiple, independent loops to be successful, load operations and store operations associated with the multiple, independent loops must be performed in a correct order. The correct order of load and store operations can be enabled by setting a precedence for the load and store operations. The load and store operations can be executed using contiguous groupings of compute elements within a 2D array of compute elements. The one or more contiguous groupings enable parallel processing of multiple loops with loads and stores. A two-dimensional (2D) array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, wherein the tagging is implemented for loop operations, and wherein the tagging is provided by the compiler at compile time. Control word data is loaded for multiple, independent loops into the compute elements. The multiple, independent loops are executed. Memory is accessed based on the precedence information, wherein the memory access includes loads and/or stores for data relating to the independent loops.

Example contiguous groupings of compute elements are shown within a two-dimensional array of compute elements 400. An array 410 can include a number of compute elements. The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, and so on. The compute elements can be coupled to local storage, which can include local memory elements, register files, cache storage, associative memories, etc. The compute elements can be further coupled to control elements, multiplier elements, arithmetic logic unit (ALU) elements, etc. The contiguous groupings of compute elements can include two or more compute elements, where the contiguous groupings can be configured in a horizontal or vertical orientation; a rectangular, square, or “straight line” orientation; etc. Example contiguous groupings of compute elements include a 1 × 4 matrix 420, a 2 × 2 matrix 422, a 4 × 4 matrix 424, a 1 × 2 matrix 426, a 3 × 1 matrix 428, a 2 × 2 matrix 430, and so on. In embodiments, the grouping can establish boundaries for the executing the multiple, independent loops. Compute elements that are grouped can load and store data based on operations performed by the compute elements within the grouping. By working within a boundary, a locality of data can be established and maintained. The locality of data can enable local storage of data that can be accessed by compute elements within the grouping. Local storage of data reduces data storage access times, reduces data access conflicts with other groupings of compute elements, and the like. Further embodiments include establishing a precedence pointer for the grouping. The precedence pointer for the grouping can keep track of control word execution, data access addresses, and so on. In embodiments, the precedence pointer indicates actual hardware progress of the loads and stores. A control element associated with the 2D array of compute elements can locally monitor progress of loop execution without having to communicate with higher level control.

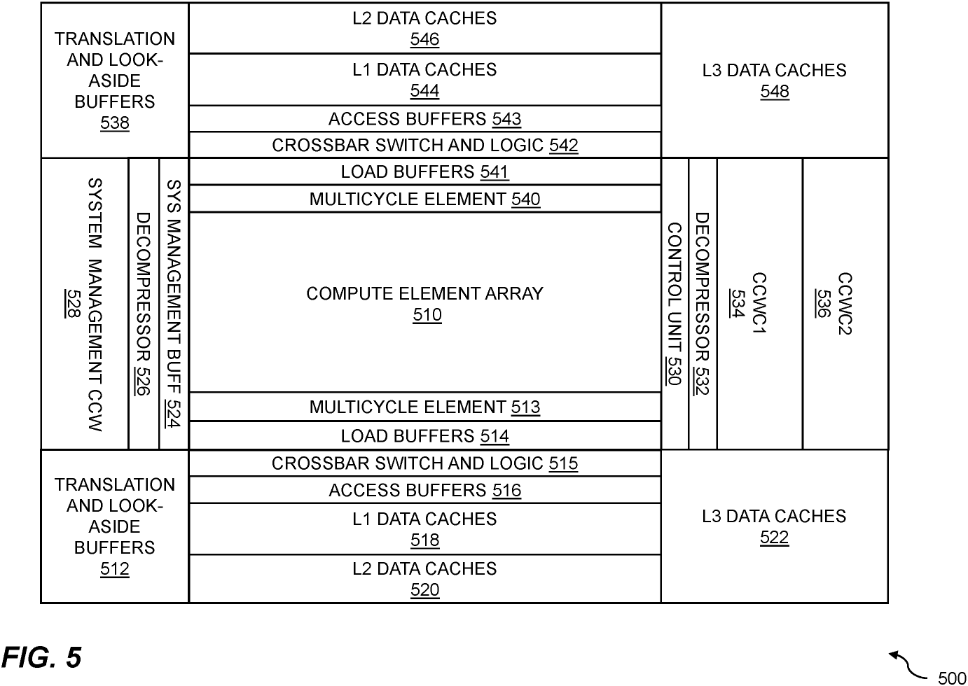

FIG. 5 illustrates a system block diagram for a highly parallel architecture with a shallow pipeline. The highly parallel architecture can comprise components including compute elements, processing elements, buffers, one or more levels of cache storage, system management, arithmetic logic units, multipliers, and so on. The various components can be used to accomplish task processing, where the task processing is associated with program execution, job processing, etc. The parallel processing is enabled by parallel processing of multiple loops with loads and stores. A two-dimensional (2D) array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, wherein the tagging is implemented for loop operations, and wherein the tagging is provided by the compiler at compile time. Control word data for multiple, independent loops is loaded into the compute elements. The multiple, independent loops are executed. Memory is accessed based on the precedence information, wherein the memory access includes loads and/or stores for data relating to the independent loops.

A system block diagram 500 for a highly parallel architecture with a shallow pipeline is shown. The system block diagram can include a compute element array 510. The compute element array 510 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 500 can include translation and look-aside buffers such as translation and look-aside buffers 512 and 538. The translation and look-aside buffers can comprise memory caches, where the memory caches can be used to reduce storage access times.

The system block diagram 500 can include logic for load and store access order and selection. The logic for load and store access order and selection can include crossbar switch and logic 515 along with crossbar switch and logic 542. Crossbar switch and logic 515 can accomplish load and store access order and selection for the lower data cache blocks (518 and 520), and crossbar switch and logic 542 can accomplish load and store access order and selection for the upper data cache blocks (544 and 546). Crossbar switch and logic 515 enables high-speed data communication between the lower-half compute elements of compute element array 510 and data caches 518 and 520 using access buffers 516. Crossbar switch and logic 542 enables high-speed data communication between the upper-half compute elements of compute element array 510 and data caches 544 and 546 using access buffers 543. The access buffers 516 and 543 allow logic 515 and logic 542, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 518 and 520 and upper data caches 544 and 546.

The system block diagram 500 can include lower load buffers 514 and upper load buffers 541. The load buffers can provide temporary storage for memory load data so that it is ready for low latency access by the compute element array 510. The system block diagram can include dual level 1 (L1) data caches, such as L1 data caches 518 and 544. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 520 and 546. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 522 and 548. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 500 can include a lower multicycle element 513 and an upper multicycle element 540. The multicycle elements (MEMs) can provide efficient functionality for operations that span multiple cycles, such as multiplication operations, or even those of indeterminant cycle length, such as some divide and square root operations. The MEMs can operate on data coming out of the compute element array and/or data moving into the compute element array. Multicycle element 513 can be coupled to the compute element array 510 and load buffers 514, and multicycle element 540 can be coupled to compute element array 510 and load buffers 541.

The system block diagram 500 can include a system management buffer 524. The system management buffer can be used to store system management codes or control words that can be used to control the array 510 of compute elements. The system management buffer can be employed for holding opcodes, codes, routines, functions, etc. which can be used for exception or error handling, management of the parallel architecture for processing tasks, and so on. The system management buffer can be coupled to a decompressor 526. The decompressor can be used to decompress system management compressed control words (CCWs) from system management compressed control word buffer 528 and can store the decompressed system management control words in the system management buffer 524. The compressed system management control words can require less storage than the uncompressed control words. The system management CCW component 528 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 530. While the compiler, through the control word, controls the individual elements, the control unit can pause the array to ensure that new control words are not driven into the array. The control unit can receive a decompressed control word from a decompressor 532 and can drive out the decompressed control word into the appropriate compute elements of compute element array 510. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 534. CCWC1 can include a cache such as an L1 cache that includes one or more compressed control words. CCWC1 can be coupled to a further compressed control word store such as compressed control word cache 2 (CCWC2) 536. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 532 can be coupled between CCWC1 534 (now DCWC1) and CCWC2 536.

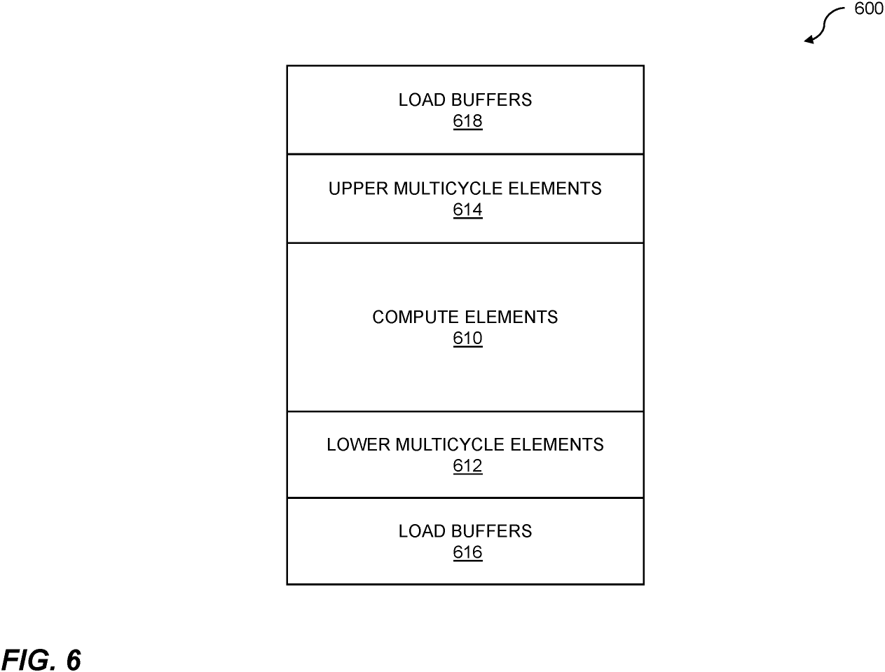

FIG. 6 shows compute element array detail 600. A compute element array can be coupled to components which enable the compute elements within the array to process one or more tasks, subtasks, and so on. The components can access and provide data, perform specific high-speed operations, and the like. The compute element array and its associated components enable parallel processing of multiple loops with loads and stores. The compute element array 610 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 612 and upper multicycle elements 614. The multicycle elements can be used to perform, for example, high-speed multiplications associated with general processing tasks, multiplications associated with neural networks such as deep learning networks, multiplications associated with vector operations, and the like. The compute elements can be coupled to load buffers such as load buffers 616 and load buffers 618. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories can be beneficial while the array is paused. This mechanism can operate such that the array state is known, as far as the compiler is concerned. When array operation resumes after a pause, new load data will have arrived at a scratchpad, as required for the compiler to maintain the statically scheduled model.

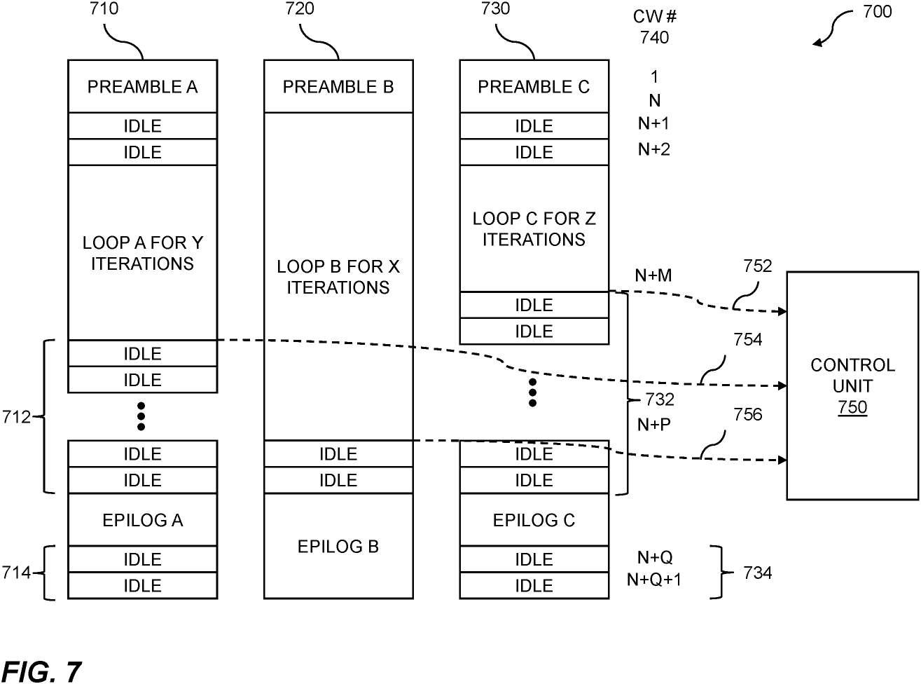

FIG. 7 shows loop implementation detail. Discussed above and throughout, multiple, independent loops can be executed by groupings of compute elements with a 2D array of compute elements. The loops can include differing numbers of operations, numbers of iterations, data requirements, and so on. Each loop can load and store data. Some of the data that can be stored by one loop can be loaded by another loop. In order to avoid a hazard condition, such as could occur when the data to be loaded by the second loop has not yet been written by the first loop, a precedence value can be determined by hardware based on precedence information. The precedence information enables parallel processing of multiple loops with loads and stores. A two-dimensional (2D) array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, wherein the tagging is for loop operations, and wherein the tagging is provided by the compiler at compile time. Control word data for multiple, independent loops is loaded into the compute elements. The multiple, independent loops are executed. Memory is accessed based on the precedence information, wherein the memory access includes loads and/or stores for data relating to the independent loops.

Implementation detail associated with the execution of three independent loops is shown 700. Each loop can include a number of operations, and each loop can be executed for a number of iterations. The number of operations and the number of iterations can vary from loop to loop. Further data that is generated and stored by a loop can be loaded and consumed by one or more additional loops. In order for the one or more additional loops to load valid data, the loop that stores the data must store valid data prior to one or more additional loops loading the stored valid data. In the figure, three parallel loops are shown. Each loop can be contained in a block such as block A 710, block B 720, and block C 730. Each block can include a preamble such as preamble A, preamble B, and preamble C; a loop of operations or compute element operations such as loop A, loop B, and loop C; and an epilog such as epilog A, epilog B, and epilog C. Each loop can be associated with a number of iterations such as Y iterations associated with loop A, X iterations associated with loop B, and Z iterations associated with loop C. A preamble can set up the one or more compute elements associated with a compute element grouping. The setting up can include accessing data; preloading data; configuring the compute elements; saving stack, signal, or pointer data; and so on. Embodiments can include scheduling idle cycles, by the compiler, in the independent loop preamble. Note that the preambles associated with the loops can include different numbers of operations. In order to “equalize” the preambles so that execution of the loops does not get out of synchronization, idle cycles can be introduced into the shorter preambles. Examples of inserted idle cycles are shown in block A 710 and block C 730. In embodiments, the preamble idle cycles can enable each compute element in the grouping of compute elements to complete preamble code before starting loop execution.

Subsequent to execution of the preamble codes, loop execution can begin. The loops can include operations, where the operations can include arithmetic operations, logical operations, matrix operations, tensor operations, etc. As was the case for the preambles including different numbers of operations, so the loops of operations can comprise different numbers of operations. The shorter loops can be padded with idle cycles. Examples of idle cycle padding include idle cycles 712 and idle cycles 732. The idle cycles can further be used to accommodate different iteration values associated with the loops. An epilog can include operations that can “conclude” loop and iteration operations. The epilog can be used to release one or more compute elements, store data that was generated by the loops, release data within a storage queue for storage, etc. As was the case for the preambles, the epilogs can include different numbers of operations. Embodiments can include scheduling idle cycles, such as idle cycles 714 and idle cycles 734, by the compiler, in the independent loop epilog. The scheduled idle cycles can equalize a number of operations, cycles, and so on within an epilog. In embodiments, the epilog idle cycles can enable each compute element in the grouping of compute elements to complete epilog code before exiting operation loop execution.

Control words associated with execution of the multiple, independent loops are shown 740. The control words, which are provided on a cycle-by-cycle basis, control the compute elements. The control words are provided to a control unit 750. The control unit can configure the compute elements that execute the operations associated with the preambles, the loops, and the epilogs discussed above. The control unit can initiate operations associated with blocks A, B, and C discussed previously. In order to keep track of the execution of independent loops, a signal, flag, semaphore, or other indicator can be used to indicate loop execution status. Embodiments include notifying a control unit by each compute element in the grouping of compute elements, based on each compute element completing loop execution. Each loop can issue a completion notification to the control unit such as completion notification 752 from loop C, completion notification 754 from loop A, and completion notification 756 from loop B. Recall that execution of a loop can include a number of iterations, where the number of iterations can vary from loop to loop. In embodiments, the notifying can indicate loop termination. The control unit can perform one or more operations upon receiving all completion notifications. Embodiments include idling each compute element in the grouping of compute elements upon loop termination. The idle cycles can be executed prior to execution of epilogs associated with each independent loop.

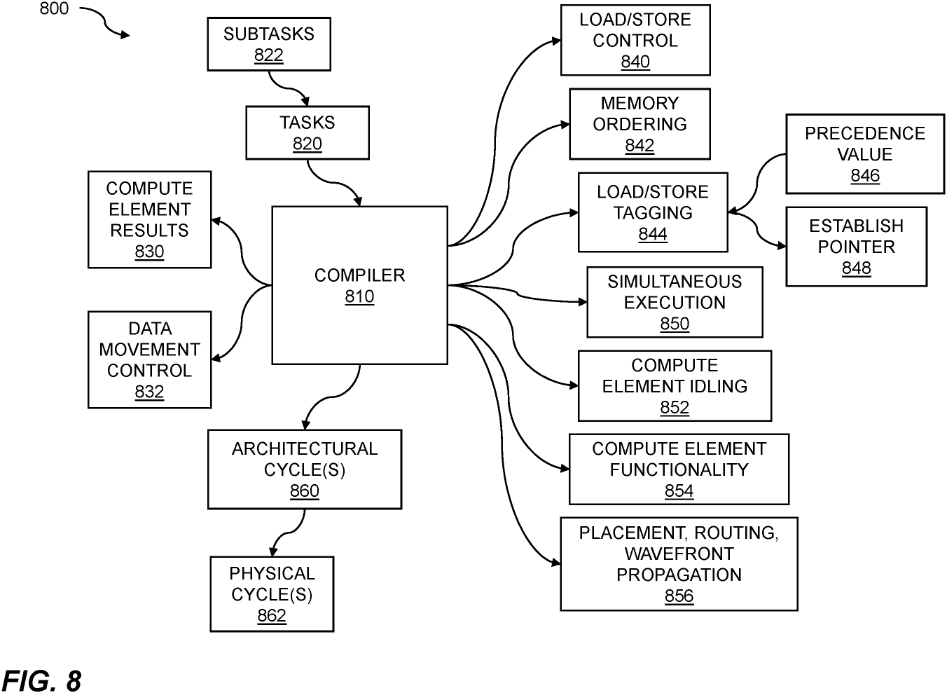

FIG. 8 illustrates a system block diagram for compiler interactions. Discussed throughout, compute elements within a 2D array are known to a compiler which can compile tasks and subtasks for execution on the array. The compiled tasks and subtasks are executed on one or more compute elements to accomplish parallel processing. A variety of interactions, such as configuration of compute elements, placement of tasks, routing of data, and so on, can be associated with the compiler. The compiler interactions enable parallel processing of multiple loops with loads and stores. A two-dimensional (2D) array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, wherein the tagging is for loop operations, and wherein the tagging is provided by the compiler at compile time. Control word data is loaded for multiple, independent loops into the compute elements. The multiple, independent loops are executed. Memory is accessed based on the precedence information, wherein the memory access includes loads and/or stores for data relating to the independent loops.

The system block diagram 800 includes a compiler 810. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 820. The tasks can include a plurality of tasks associated with a processing task. The tasks can further include a plurality of subtasks 822. The tasks can be based on an application such as a video processing or audio processing application. In embodiments, the tasks can be associated with machine learning functionality. The compiler can generate directions for handling compute element results 830. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 832 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement. The loading and storing of data can be based on precedence. In embodiments, a precedence value can be determined by the hardware, based on the precedence information. The hardware can derive the precedence value based on compiler information. In embodiments, the precedence information can include a template value supplied by the compiler.

As with a general-purpose compiler used for generating tasks and subtasks for execution on one or more processors, the compiler can provide directions for task and subtask handling, input data handling, intermediate and final result data handling, and so on. The compiler can further generate directions for configuring the compute elements, storage elements, control units, ALUs, and so on associated with the array. As previously discussed, the compiler generates directions for data handling to support the task handling. In the system block diagram, the data movement can include control of data loads and stores 840 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 842. Memory data can be ordered based on task data requirements, subtask data requirements, task priority or precedence, and so on. The memory data ordering can enable parallel execution of tasks and subtasks.

In the system block diagram 800, the ordering of memory data can be based on load and/or store tagging 844. In embodiments, memory access operations can be tagged with precedence information. The tagging is contained in the control words, the tagging is for loop operations, and the tagging is provided by the compiler at compile time. The tagging can be used to order load operations and store operations. In the system block diagram 800, a precedence value 846 can be determined, or calculated, by the hardware, based on the precedence information provided by the compiler at compiler time. The precedence value can indicate an order for loading and storing, which loads and stores can be performed substantially simultaneously, etc. In embodiments, the precedence information can include a template value supplied by the compiler. The template value can include a value, a relative value, and so on. In embodiments the template value can include a seed value. The template value can be used to orchestrate loads and stores. In embodiments, the precedence value can enable hardware ordering of the loads and stores. The flow 800 further includes a precedence pointer 848. The precedence pointer can be established for a grouping of compute elements within the array of compute elements. The groupings of compute elements can include contiguous groupings. In embodiments, the precedence pointer can indicate actual hardware progress of the loads and stores.

The system block diagram includes enabling simultaneous execution 850 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, the sequence of control words associated with the correct branch result continues execution, while the operations for the branch path not taken are halted and side effects may be flushed. In embodiments, the two or more potential branch paths can be executed on spatially separate compute elements within the array of compute elements. The simultaneous execution can include substantially simultaneous execution of multiple, independent loops. An independent loop can represent a portion of a subtask, a subtask, a portion of a task, a task, etc.

The system block diagram includes compute element idling 852. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 854. The compute element functionality can enable various types of computer architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 856 within the array of compute elements. The compiler can generate directions or operations that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements.

In the system block diagram, the compiler can control architectural cycles 860. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory queue to clear. In the system block diagram, the architectural cycle can include one or more physical cycles 862. A physical cycle can refer to one or more cycles at the element level that are required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. Various operand sizes can be used. In embodiments, the operand size can include bytes, half-words, words, and double-words.

Discussed above and throughout, the control word bits comprise a control word bunch. A control word bunch can include a subset of bits in a control word. In embodiments, the control word bunch can provide operational control of a particular compute element, a multiplier unit, and so on. Buffers, or “bunch buffers” can be placed at each control element. In embodiments, the bunch buffers can hold a number of bunches such as 16 bunches. Other numbers of bunches such as 8, 32, 64 bunches, and so on, can also be used. The output of a bunch buffer associated with a compute element, multiplier element, etc., can control the associated compute element or multiplier element. In embodiments, an iteration counter can be associated with each bunch buffer. The interaction counter can be used to control a number of times that the bits within the bunch buffer are cycled through. In further embodiments, a bunch buffer pointer can be associated with each bunch buffer. The bunch buffer counter can be used to indicate or “point to” the next bunch of control word bits to apply to the compute element or multiplier element. In embodiments, data paths associated with the bunch buffers can be balanced during a compile time associated with processing tasks, subtasks, and so on. The balancing the data paths can enable compute elements to operate without the risk of a single compute element being starved for data, which could result in stalling the two-dimensional array of compute elements as data is obtained for the compute element. Further, the balancing the data paths can enable an autonomous operation technique. In embodiments, the autonomous operation technique can include a dataflow technique.

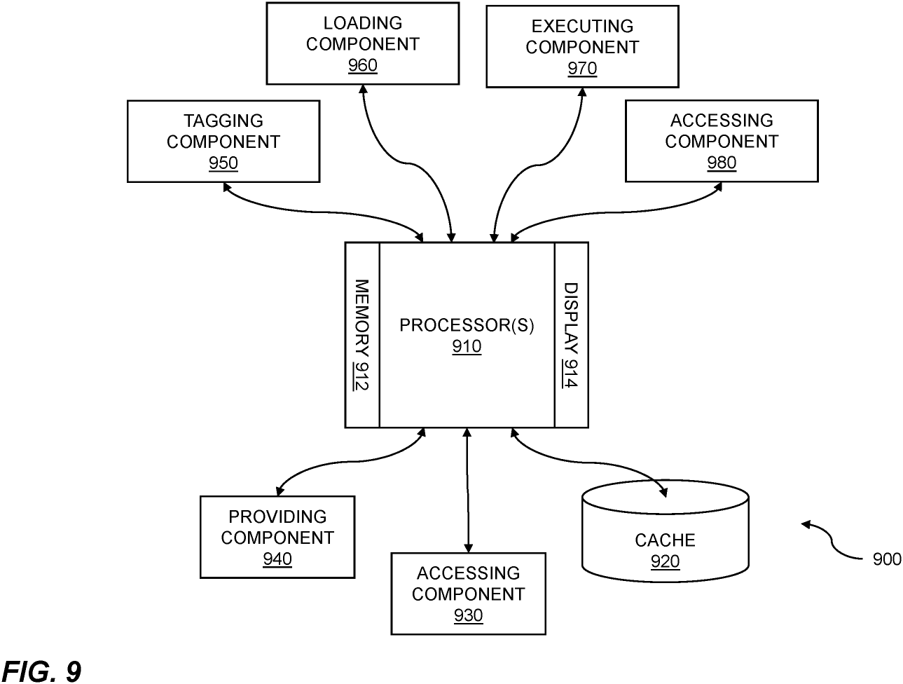

FIG. 9 is a system diagram for parallel processing of multiple loops with loads and stores. The parallel processing of multiple loops with loads and stores accomplishes parallel processing, such as parallel processing of tasks, subtasks, and so on, within a 2D array of compute elements. The system 900 can include one or more processors 910, which are attached to a memory 912 which stores instructions. The system 900 can further include a display 914 coupled to the one or more processors 910 for displaying data; intermediate steps; directions; control words; precedence information; template values; precedence pointers; code preambles and epilogs; compressed control words; control words implementing Very Long Instruction Word (VLIW) functionality; topologies including systolic, vector, cyclic, spatial, streaming, or VLIW topologies; and so on. In embodiments, one or more processors 910 are coupled to the memory 912, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; provide control for the compute elements on a cycle-by-cycle basis, wherein control is enabled by a stream of wide control words generated by the compiler; tag memory access operations with precedence information, wherein the tagging is contained in the control words, wherein the tagging is implemented for loop operations, and wherein the tagging is provided by the compiler at compile time; load control word data for multiple, independent loops into the compute elements; execute the multiple, independent loops; and access memory based on the precedence information, wherein the memory access includes loads and/or stores for data relating to the independent loops. The compute elements can include compute elements within one or more integrated circuits or chips, compute elements or cores configured within one or more programmable chips such as application specific integrated circuits (ASICs), field programmable gate arrays (FPGAs), heterogeneous processors configured as a mesh, standalone processors, etc.

The system 900 can include a cache 920. The cache 920 can be used to store data such as scratchpad data, operations that support a balanced number of execution cycles for a data-dependent branch, directions to compute elements, memory access operation tags, template values, precedence pointer data, intermediate results, microcode, branch decisions, and so on. The cache can comprise a small, local, easily accessible memory available to one or more compute elements. In embodiments, the data that is stored can include preloaded data that can enable parallel processing of multiple loops with loads and stores. The data within the cache can include data required to support dataflow processing by statically scheduled compute elements within the 2D array of compute elements. The cache can be accessed by one or more compute elements. The cache, if present, can include a dual read, single write (2R1W) cache. That is, the 2R1W cache can enable two read operations and one write operation contemporaneously without the read and write operations interfering with one another.

The system 900 can include an accessing component 930. The accessing component 930 can include control logic and functions for accessing a two-dimensional (2D) array of compute elements. Each compute element within the array of compute elements is known to a compiler and is coupled to its neighboring compute elements within the array of compute elements. A compute element can include one or more processors, processor cores, processor macros, processor cells, and so on. Each compute element can include an amount of local storage. The local storage may be accessible by one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX). Compute elements with the 2D array of compute elements can be configured as a topologic set, where a topological set of compute elements can include a subset of compute elements within the 2D array of compute elements. The topological set of compute elements can include compute elements arranged to perform operations that enable systolic, vector, cyclic, spatial, and streaming processing, operations based on VLIW instructions (e.g., command words), and the like.

The system 900 can include a providing component 940. The providing component 940 can include control and functions for providing control for the compute elements on a cycle-by-cycle basis, wherein control is enabled by a stream of wide control words generated by the compiler. The control words can be based on low-level control words such as assembly language words, microcode words, and so on. The control can include a control word bunches. In embodiments, the control word bunches can provide operational control of a particular compute element. The control of the array of compute elements on a cycle-by-cycle basis can include configuring the array to perform various compute operations. In embodiments, the stream of wide control words generated by the compiler provides direct, fine-grained control of the 2D array of compute elements. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

The system 900 can include a tagging component 950. The tagging component 950 can include control and functions for tagging memory access operations with precedence information, wherein the tagging is contained in the control words, wherein the tagging is implemented for loop operations, and wherein the tagging is provided by the compiler at compile time. The memory operations, which can include load (read) operations and store (write) operations, can be associated with one or more control words generated by the compiler. The order in which one or more load operations and one or more store operations are executed is critical. In a usage example, a second subtask operates on data generated by a first subtask. In order for the second subtask to perform operations on valid data generated by the first subtask, the second subtask can wait until the first subtask has generated valid data for the second subtask. Thus, a data store operation associated with the first subtask has a higher precedence than the load operation associated with the second subtask. Since multiple tasks and subtasks can be executed on the 2D array of compute elements substantially simultaneously, the ordering or precedence of load and store operations must be carefully orchestrated. The load and store operations can be managed by a control element associated with the 2D array.

In embodiments, a precedence value can be determined by the hardware, based on the precedence information. The compiler can generate control words, such as control words associated with one or more loops such as processing loops. While the compiler can specify what operations are to be performed on which datasets, the compute elements within the 2D array of compute elements can operate autonomously while executing control words associated with one or more loops. Using hardware to determine the precedence value enables the autonomous operation of the compute elements. In embodiments, the precedence information can include a template value supplied by the compiler. A template value can include a specific value, a relative value, a random value, and so on. In embodiments, the template value includes a seed value. The seed value can be used as a basis for generating, calculating, determining, etc. a precedence value. In further embodiments, the precedence value can enable hardware ordering of the loads and stores. The ordering of the loads and stores can be accomplished by identifying load hazards and store hazards and by introducing a delay into data operations such as data store operations. In embodiments, the hazards can include write-after-read, read-after-write, and write-after-write conflicts, etc.

The system block diagram 900 can include a loading component 960. The loading component 960 can include control and functions for loading control word data for multiple, independent loops into the compute elements. In embodiments, an associative memory is included in each compute element of the topological set of compute elements. The associative memory can include a small, fast memory, a register file, etc. The associative memory can store control word data for multiple, independent loops. The control word data, which can include one or more control words, can be used to provide control for the array of compute elements on a cycle-by-cycle basis. The control word data can be based on low-level control words such as assembly language words, microcode words, and so on. The control can be based on bits, where control word bits comprise a control word bunch. The control of the array of compute elements on a cycle-by-cycle basis can include configuring the array to perform various compute operations. In embodiments, a stream of wide control words generated by the compiler can provide direct, fine-grained control of the 2D array of compute elements. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

The system block diagram 900 can include an executing component 970. The executing component 970 can include control and functions for executing the multiple, independent loops. The multiple, independent loops can be executed on one or more compute elements within the 2D array of compute elements. Embodiments further include establishing a grouping of compute elements within the array of compute elements. More than one grouping of compute elements can be established. An independent loop can be allocated to a grouping. The independent loop can be allocated to more than one grouping to enable parallel processing. In embodiments, the grouping establishes boundaries for the executing the multiple, independent loops. The boundaries can enable data locality, where data locality can minimize cross-boundary data access, transfer, etc., thereby improving speed of execution of an independent loop. Recall that the executing multiple, independent loops can be based on precedence. Embodiments further include establishing a precedence pointer for the grouping. A precedence pointer can be used to determine a point of operation (e.g., a program counter) within the multiple, independent loops. In embodiments, the precedence pointer can indicate actual hardware progress of the loads and stores.

The compute element operations that are executed can include task processing operations, subtask processing operations, and so on. The operations associated with tasks, subtasks, and so on can include arithmetic operations, Boolean operations, matrix operations, neural network operations, and the like. The operations can be executed based on the specific set of compute element operations associated with the multiple, independent loops. The specific set of compute element operations can be generated by the compiler. The control words can be provided to a control unit where the control unit can control the operations of the compute elements within the array of compute elements. Operation of the compute elements can include configuring the compute elements, providing data to the compute elements, routing and ordering results from the compute elements, and so on. In embodiments, the specific set of compute element operations associated with control words can be executed on a given cycle across the array of compute elements. The set of compute element operations can provide control to a set of compute elements on a per compute element basis, where each control word can be comprised of a plurality of compute element control groups, clusters, and so on.

The executing operations contained in one or more specific sets of compute element operations can include distributed execution of operations. In embodiments, the distributed execution of operations can occur in two or more compute elements within the array of compute elements. The executing operations can include storage access, where the storage can include a scratchpad memory, one or more caches, register files, etc. within the 2D array of compute elements. Further embodiments include a memory operation outside of the array of compute elements (discussed further below). The “outside” memory operation can include access to a memory such as a high-speed memory, a shared memory, remote memory, etc. In embodiments, the memory operation can be enabled by autonomous compute element operation. Data operations can be performed by a topological set of compute elements without loading further control words for a number of cycles. The autonomous compute element operation can be based on operation looping. In embodiments, the operation looping can accomplish dataflow processing within statically scheduled compute elements. Dataflow processing can include processing based on the presence or absence of data. The dataflow processing can be performed without requiring access to external storage. Discussed above and throughout, the executing can occur on an architectural cycle basis. An architectural basis can include a compute element cycle. In embodiments, the architectural cycle basis can reflect non-wall clock, compiler time.

The system block diagram 900 can include an accessing component 980. The accessing component 980 can include control and functions for accessing memory based on the precedence information, wherein the memory access includes loads and/or stores for data relating to the independent loops. The accessing memory to accomplish one or more loads and one or more stores can be based on one or more precedence values determined by the hardware. Data to be loaded or to be stored can be held in a buffer such as an access buffer prior to loading or storing, respectively. In embodiments, a store operation can be cleared from an access buffer when the precedence pointer is greater than the precedence value of the store operation and all load operations with lower precedence values have completed. The ordering of one or more load operations and one or more store operations is critical in order to avoid hazards. A hazard can occur when invalid data overwrites valid data, data is loaded (read) prior to the data becoming valid, etc. Further embodiments include identifying load hazards and store hazards by comparing load and store addresses to contents of an access buffer. The identifying can be based on including the precedence value in the comparison. Recall that data to be stored can be loaded into a store buffer prior to transfer from the store buffer to storage. Embodiments include delaying promoting data to the store buffer. The delaying can accomplish an order in which data can be stored or loaded to avoid overwriting valid data, loading invalid data, etc. In embodiments, the delaying can avoid hazards, where the hazards can include write-after-read, read-after-write, write-after-write conflicts, and so on. In other embodiments, the avoiding hazards can be based on a comparative precedence value. In a usage example, higher precedence value operations can be performed before lower precedence operations.

The system 900 can include a computer program product embodied in a non-transitory computer readable medium for parallel processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; providing control for the compute elements on a cycle-by-cycle basis, wherein control is enabled by a stream of wide control words generated by the compiler; tagging memory access operations with precedence information, wherein the tagging is contained in the control words, wherein the tagging is implemented for loop operations, and wherein the tagging is provided by the compiler at compile time; loading control word data for multiple, independent loops into the compute elements; executing the multiple, independent loops; and accessing memory based on the precedence information, wherein the memory access includes loads and/or stores for data relating to the operation loops.

Each of the above methods may be executed on one or more processors on one or more computer systems. Embodiments may include various forms of distributed computing, client/server computing, and cloud-based computing. Further, it will be understood that the depicted steps or boxes contained in this disclosure’s flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions-generally referred to herein as a “circuit,” “module,” or “system”- may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for parallel processing comprising:
accessing a two-dimensional (2D) array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
tagging memory access operations with precedence information, wherein the tagging is contained in the control words, wherein the tagging is for loop operations, and wherein the tagging is provided by the compiler at compile time;
loading control word data for multiple, independent loops into the compute elements;
executing the multiple, independent loops; and
accessing memory based on the precedence information, wherein the memory access includes loads and/or stores for data relating to the independent loops.

2. The method of claim 1 wherein a precedence value is determined by logic, based on the precedence information.

3. The method of claim 1 wherein the precedence information comprises a template value supplied by the compiler.

4. The method of claim 3 wherein the template value includes a seed value.

5. The method of claim 1 wherein a precedence value enables hardware ordering of the loads and stores.

6. The method of claim 1 further comprising establishing a grouping of compute elements within the array of compute elements.

7. The method of claim 6 wherein the grouping establishes boundaries for the executing the multiple, independent loops.

8. The method of claim 6 further comprising establishing a precedence pointer for the grouping.

9. The method of claim 8 wherein the precedence pointer indicates actual hardware progress of the loads and stores.

10. The method of claim 8 wherein a store operation is cleared from an access buffer when the precedence pointer is greater than a precedence value of the store operation and all load operations with lower precedence values have completed.

11. The method of claim 6 further comprising identifying load hazards and store hazards by comparing load and store addresses to contents of an access buffer.

12. The method of claim 11 further comprising including a precedence value in the comparing.

13. The method of claim 11 further comprising delaying promoting data to a store buffer.

14. The method of claim 13 wherein the delaying avoids hazards.

15. The method of claim 14 wherein the avoiding hazards is based on a comparative precedence value.

16. The method of claim 14 wherein the hazards include write-after-read, read-after-write, and write-after-write conflicts.

17. The method of claim 6 further comprising dynamically coupling at least one grouping of compute elements at run time.

18. The method of claim 17 further comprising notifying a control unit by each compute element in the at least one grouping of compute elements, based on each compute element completing loop execution.

19. The method of claim 18 wherein the notifying indicates loop termination.

20. The method of claim 19 further comprising idling each compute element in the grouping of compute elements upon loop termination.

21. The method of claim 1 wherein the independent loops include code for a preamble, a loop, and an epilog.

22. The method of claim 21 further comprising scheduling idle cycles, by the compiler, in the independent loop preamble.

23. The method of claim 22 wherein the preamble idle cycles enable each compute element in a grouping of compute elements to complete preamble code before starting loop execution.

24. The method of claim 21 further comprising scheduling idle cycles, by the compiler, in the independent loop epilog.

25. The method of claim 24 wherein the epilog idle cycles enable each compute element in a grouping of compute elements to complete epilog code before exiting instruction loop execution.

26. A computer program product embodied in a non-transitory computer readable medium for parallel processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
tagging memory access operations with precedence information, wherein the tagging is contained in the control words, wherein the tagging is for loop operations, and wherein the tagging is provided by the compiler at compile time;
loading control word data for multiple, independent loops into the compute elements;
executing the multiple, independent loops; and
accessing memory based on the precedence information, wherein the memory access includes loads and/or stores for data relating to the independent loops.

27. A computer system for parallel processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
provide control for the compute elements on a cycle-by-cycle basis, wherein control is enabled by a stream of wide control words generated by the compiler;
tag memory access operations with precedence information, wherein the tagging is contained in the control words, wherein the tagging is for loop operations, and wherein the tagging is provided by the compiler at compile time;
load control word data for multiple, independent loops into the compute elements;
execute the multiple, independent loops; and
access memory based on the precedence information, wherein the memory access includes loads and/or stores for data relating to the independent loops.
